(19) United States
(12) Patent Application Publication
(10) Pub. No.: US 2012/0186320 A1
(43) Pub. Date: Jul. 26, 2012

(54) METHOD AND MACHINE TOOL FOR THE PROCESSING AND HARDENING OF METALLIC WORKPIECES

(76) Inventors: Moshe Israel Meidar, New York, NY (US); Wolfgang Horn, Goppingen (DE); Heiner Lang, Pforzheim (DE)

(21) Appl. No.: 13/354,691

(22) Filed: Jan. 20, 2012

(30) Foreign Application Priority Data
Jan. 21, 2011 (DE) 102011003004.2

(51) Int. Cl. B21D 43/28; B26D 7/00; C21D 1/62; C22F 1/00; C21D 1/18

(52) U.S. Cl. 72/324; 148/559; 266/160

(57) ABSTRACT

A method and a machine tool are disclosed for processing and hardening metallic workpieces. The workpieces are clamped in workpiece holders and are first processed with metal cutting by means of a processing device and are then hardened by means of a hardening device. For hardening, the processed workpiece is first heated by means of a heating unit and then quenched by means of a quenching unit. The quenching occurs by means of a cryogenic cooling medium, e.g., liquid or gaseous nitrogen. Because the processing and hardening of the workpiece occurs in a clamping device, and the fast quenching of the heated workpiece, a high processing quality and short processing and/or cycle times are achieved.

### FIELD

The invention relates to a method and a machine tool for the processing and hardening of metallic workpieces.

### BACKGROUND

From DE 197 49 939 C2 (corresponds to U.S. Pat. No. 6,684,500 B1) a machine tool for processing crankshafts is known, in which the crankshafts are machined in a clamping device and then hardened. For hardening, the crankshafts are heated by means of a laser or an inductor. The disadvantage is that, after cooling, the crankshafts exhibit undesirable distortion that has a negative effect on the processing and may possibly make reprocessing necessary.

The invention is based on the object of providing a method that makes possible a simple processing and hardening of metallic workpieces with high processing quality.

The workpiece to be processed and hardened is tensioned in a clamping device. For hardening, the processed workpiece is heated in the usual manner and then quenched with a cryogenic cooling medium. The cryogenic cooling medium, which upon contact with the workpiece has a very low temperature of far below 0° C. (273, 15 K), leads to a correspondingly fast cooling of the warmed workpieces, whereby the distortion is low, and clearly reduced in comparison to the state of the art. Because of this, the hardened workpieces have a high processing quality. The low distortion leads to a case in which the hardened workpieces do not have to be processed anymore at all due to the distortion or only reworked to a limited extent. Because of the fast cooling and the reworking that is no longer required, the processing time and/or cycle time is also reduced. Since the cryogenic cooling medium evaporates, neither the workpieces nor the machine tool is soiled by the cryogenic cooling medium. Disposal of the cryogenic cooling medium is not required.

The workpiece is heated by means of a heating unit, which is preferably designed as a laser and/or inductor that can be driven in a linear manner along the workpiece. In order to achieve a continuous application of heat to the workpiece, the heating preferably occurs with a rotating workpiece while driving through the heating unit. Immediately after that, the quenching of the heated workpiece occurs by means of a quenching unit that can be driven in a linear manner along the workpiece. The quenching unit is used for feeding the cryogenic cooling medium to the heated workpiece and is arranged next to the heating unit. For continuous and targeted cooling of the workpiece, the quenching preferably occurs with a rotating workpiece.

Quenching of the workpiece is fast and clean. Liquid or gaseous nitrogen, liquid or gaseous oxygen, gaseous hydrogen, gaseous helium, liquid or gaseous argon, gaseous carbon dioxide and liquid or gaseous natural gas are suitable as a cooling medium. Preferably nitrogen is used.

The disclosed method ensures low distortion of the workpiece, since during quenching, the heat of the workpiece is essentially carried away by convection only. The cryogenic cooling medium can either be stored as a gas and guided to the workpiece or stored as a liquid and only become gaseous during the feed to workpiece.

The disclosed method makes possible extremely low temperatures of the cryogenic cooling medium and a correspondingly fast quenching of the workpiece.

The disclosed method ensures storage of the cryogenic cooling medium that is simple and optimized with regard to construction space.

The disclosed method makes possible a lower processing and/or cycle time. The cryogenic cooling medium cools the blade of the tool significantly more effectively than previous cooling media, whereby higher cutting speeds and a correspondingly higher metal-cutting productivity, as well as longer tool service lives, are achievable. Because of the fact that the cryogenic cooling medium is provided anyway for quenching the workpiece, the additional effort for cooling the tool during metal cutting is low. After the cryogenic cooling medium evaporates, the entire processing can be performed dry, i.e., without the previous cooling lubricants. The processed workpieces and machine tool are thus absolutely clean. Since no cooling lubricant has to be disposed of, corresponding costs can be saved.

The disclosed method shortens the processing time. Because of the fact that the metal cutting and hardening occur in a clamping device, both process steps can occur in parallel. While by means of a machining device, machining can still occur, by means of the heating unit and/or the quenching unit, the processed workpiece can already be hardened by local heating and quenching. The parallel metal-cutting processing and hardening is especially useful for shaft-shaped workpieces with relatively large axial dimensions.

The disclosed method ensures a high processing quality, since the fine processing of the workpiece occurs in the same clamping device. A slight distortion of the workpiece due to the hardening can thus be reworked easily and quickly. In addition, other process steps for surface finishing can be performed easily and quickly.

The disclosed method ensures a short processing time. Because of the cryogenic cooling medium, the tool used for fine processing can be cooled more effectively, whereby higher processing speed and productivity and longer tool service lives result. Since cryogenic cooling medium is provided anyway for hardening, the additional effort is low for cooling the tool used during fine machining. Since the cryogenic cooling medium evaporates, both the fine-processed workpiece and the tool are absolutely clean. Disposal of previous cooling lubricants is completely eliminated.

The disclosed method shortens the processing time, since the fine processing occurs in parallel with the hardening of the workpiece. The parallel processing is made possible especially in that the workpiece cools extremely quickly due to the cryogenic cooling medium. The parallel processing is especially useful for shaft-shaped workpieces with a large axial dimension.

The disclosed method ensures a high processing quality. Because of the fact that the workpiece holder is thermally insulated with respect to the base frame, thermal distortion in the clamping device can be minimized, whereby the forces acting on the workpiece due to the clamping device remain essentially the same during the entire processing. Distortions of the workpiece caused by the clamping device are thus avoided.

The disclosed method ensures a high processing quality in the processing of shaft-shaped workpieces. Axial expansions of the clamped workpieces are compensated by the elastic mounting, so forces that act on the workpiece as a result of the clamping remain essentially the same during the entire processing. Because of an adjustment of one of the workpiece holders depending on the measured axial force, axial expansions of the clamped workpiece can be compensated simply and quickly, whereby the forces acting on the workpiece remain essentially uniform during the entire processing.

The invention is also based on the object of providing a machine tool, which makes possible simple processing and hardening of metallic workpieces with a high processing quality.

The advantages of the machine tool according to the invention correspond to the advantages of the method according to the invention already named. In particular, the machine tool according to the invention can also be further developed.

Further characteristics, advantages and details of the invention will be seen from the following example of an exemplary embodiment.

### BRIEF DESCRIPTION OF THE DRAWINGS

FIG. 1 is a perspective view of a machine tool during the metal-cutting processing of a metallic workpiece.

FIG. 2 is a partially cutaway view of the machine tool of FIG. 1.

FIG. 3 is a detail view of a processing and a hardening device of the machine tool of FIG. 1.

FIG. 4 is a perspective view of the machine tool of FIG. 1 during hardening of the machined workpieces.

FIG. 5 is a partially cutaway view of the machine tool of FIG. 4.

FIG. 6 is a perspective representation of the machine tool of FIG. 1 during fine processing of the hardened workpieces.

### DETAILED DESCRIPTION

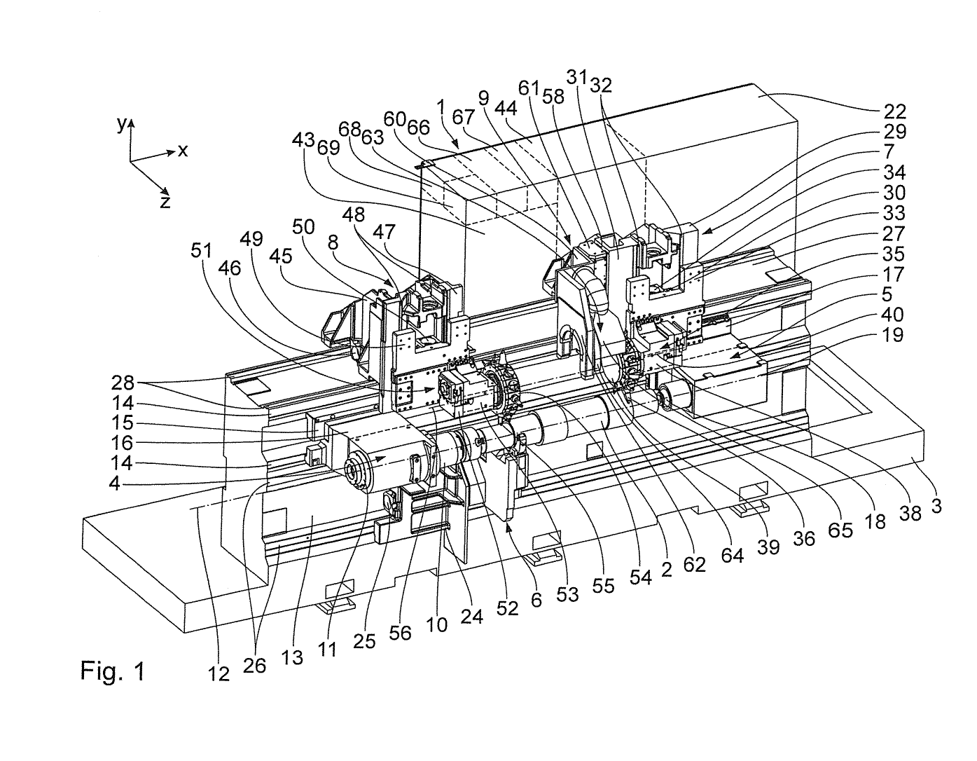

As shown in FIG. 1, a machine tool 1 for producing hardened shaft-shaped workpieces 2 of metal has a base frame 3, on which three workpiece holders 4 to 6, two processing devices 7, 8 and a hardening device 9 are mounted.

The first workpiece holder 4 is designed as a workpiece spindle and has a clamping chuck 10 that can be rotary driven by means of a spindle drive motor 11 around an axis of rotation 12 running parallel to an x-direction. The workpiece spindle 4 is mounted on a front side 13 of the base frame 3 and can be driven in a linear manner parallel to the x-direction. For this purpose, on the front side 13, first x-guide rails 14 are arranged at a distance from each other in a y-direction running perpendicular to the x-direction, on which, by means of a first x-slide 15, the workpiece spindle 4 is mounted. The x-slide 15 can be driven in a linear manner by means of a first x-drive motor 16 along the x-guide rails 14.

By means of a second x-slide 17, the second workpiece holder 5 is mounted opposite the workpiece spindle 4 on the x-guide rails 14. The workpiece holder 5 is in the form of tailstock and has a workpiece holder 18 that runs to a point, which is mounted concentrically to the axis of rotation 12 and is mounted in a housing 19 so it can rotate. The workpiece holder 18 is spring-mounted in the housing 19 by means of a spring element 20 and can be moved axially in the x-direction opposite the spring force of the spring element 20. For measuring an axial force on the workpiece holder 18, a force sensor 21 is mounted between it and housing 19 and sends the measured values of the axial force to a control device 22. Between the workpiece holder 18 and housing 19, thermal insulation 23 is arranged that thermally insulates the workpiece holder 18 with respect to the housing 19.

The third workpiece holder 6 is designed as a rest and mounted below the workpiece 2 in relationship to the y-direction. The rest 6 is fastened on a third x-slide 24, which by means of a third x-drive motor 25 is driven in a linear manner on second x-guide rails 26 parallel to the x-direction. The x-guide rails 26 are arranged at a distance from each other in the y-direction and below the x-guide rails 14 on the front side 13. The x-guide rails 14 and 26 run parallel to each other.

The processing devices 7, 8 are used for metal-cutting processing of the clamped workpieces 2. On the upper side 27 of the base frame 3, third x-guide rails 28 are mounted, which are at a distance from each other in a z-direction running perpendicular to the x- and y-directions and run parallel to the x-direction. On the x-guide rails 28 a fourth x-slide 29 is mounted, and by means of a fourth x-drive motor 30, can be driven in a linear manner parallel to the x-direction. On one front side 31 of x-slide 29, first y-guide rails 32 are arranged that are at a distance from each other in the x-direction and run parallel to the y-direction. On the y-guide rails 32, a first y-slide 33 is mounted, which by means of a y-drive motor 34 can be driven in a linear manner parallel to the y-direction. On the y-slide 33, a first tool turret 35 with a number of tools 36 is fastened. The tool turret 35 has a housing 37, in which a revolving drive motor 38 is mounted, by means of which a revolving disk 39 can be rotary-driven around an axis of rotation 40. The axes of rotation 12 and 40 run parallel to each other and parallel to the x-y plane.

For feeding a cryogenic cooling medium 41 the processing device 7 has a feed line 42, which leads from a reservoir tank 43 to the tool 36 that is at that time in engagement with the workpiece 2. The feed line 42 runs, for example, through the revolving disk 39 and the tool 36 that is in engagement, directly to the blade of the tool 36. The reservoir tank 43 is thermally insulated and can be cooled by means of a cooling unit 44. The cryogenic cooling medium 41 can be transported by means of a first feed pump 68 through the feed line 42 to the tool 36.

The second processing device 8 is designed corresponding to the first processing device 7 and has a fifth x-slide 45 that can be driven parallel to the x-direction in a linear manner on the x-guide rails 28 by means of a fifth x-drive motor 46. On one front side 47 of the x-slides 45, second y-guide rails 48 are mounted, on which a second y-slide 49 can be driven in a linear manner parallel to the y-direction by means of a second y-drive motor 50. On the y-slide 49 a second tool turret 51 is mounted, which is turned toward the first tool turret 35. The tool turret 51 has housing 52, in which a revolving drive motor 53 is mounted. By means of the revolving drive motors 53, a revolving disk 54 can be driven in rotation with tools 55 around an axis of rotation 56. The axis of rotation 56 is arranged congruently to the axis of rotation 40. For feeding the cryogenic cooling medium 41 to the blade of the tool 55 in engagement, a second feed line 57 is arranged between the reservoir tank 43 and the tool 55. The feed line 57 runs, for example, through the revolving disk 54 and the tool 55 that is in engagement. The cryogenic cooling medium 41 can be transported by means of a second feed pump 69 from the reservoir tank 43 to the tool 55.

The hardening device 9 is arranged parallel to the y-direction in linear manner so it can travel on the x-slide 29. For this purpose, on a face side 58 of the x-slide 29, third y-guide rails 59 are mounted at a distance from each other in z-direction. On the y-guide rails 59, a third y-slide 60 is mounted and can be driven in a linear manner by means of a third y-drive motor 61. The hardening device 9 comprises a U-shaped heating unit 62 and a quenching unit 63 that are mounted next to each other on the y-slide 60. The heating unit 62 is designed as an inductor so that the workpiece 2 can be heated by means of induction. The quenching unit 63 comprises a feed line 64 for feeding the cryogenic cooling medium 41 and a suction line 65 for draining the cryogenic cooling medium 41 after quenching the workpiece 2. The feed line 64 leads from the reservoir tank 43 directly to the inductor 62. The cryogenic cooling medium 41 can be transported from reservoir tank 43 through the feed line 64 to the workpiece 2 by means of a third feed pump 66. The suction occurs by means of a fourth feed pump 67. Preferably the suctioned cryogenic cooling medium 41 is transported back to the reservoir tank 43.

The drive motors 11, 16, 25, 30, 34, 38, 46, 50, 53 and 61 and the feed pumps 66 to 69 are connected to the control device 22 and can be controlled by it.

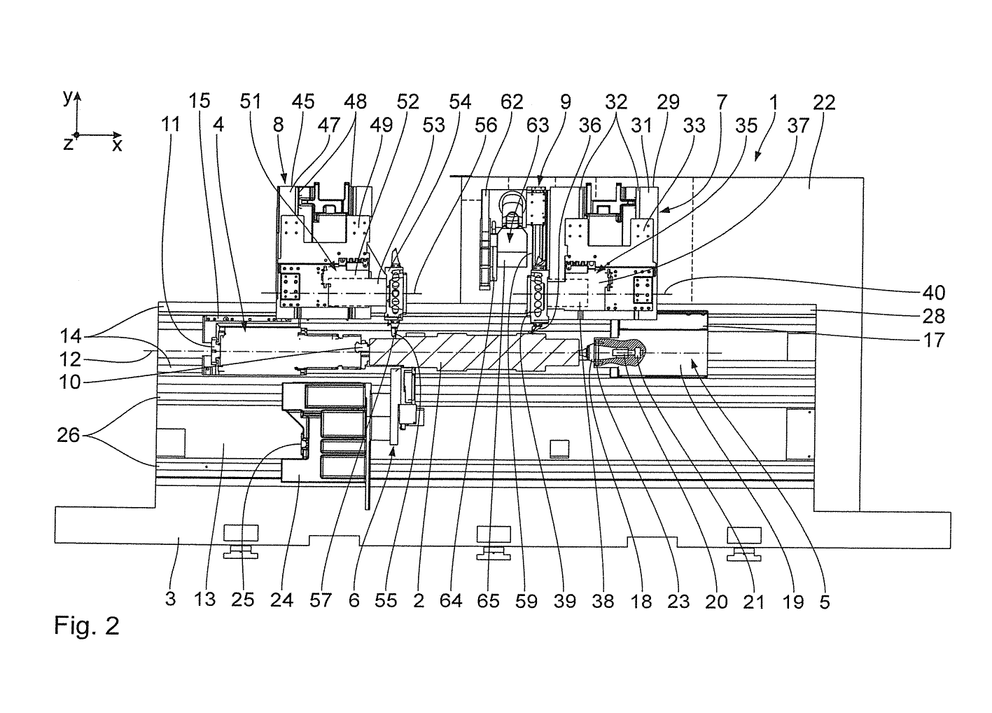

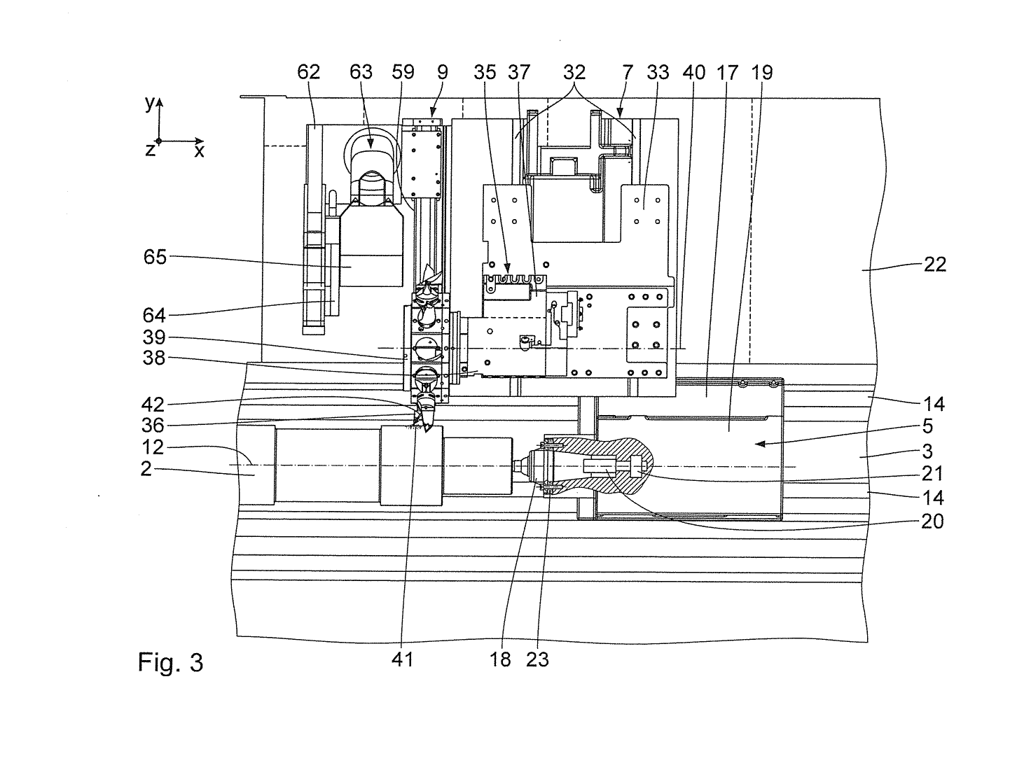

The processing and hardening of the workpiece 2 by means of the machine tool 1 are described in the following. The workpiece 2 is first clamped between the workpiece spindle 4 and the tailstock 5 and supported by means of the rest 6. Then the workpiece 2 is driven in rotation by means of the workpiece spindle 4 and metal-cutting processed by means of the processing device 7 and/or the processing device 8. The tools 36 and/or 55 in engagement with the workpiece 2 are cooled by means of the cryogenic cooling medium 41. For this purpose, the cooling medium 41 is transported by means of the feed pumps 68, 69 through the feed lines 42, 57 to the blades of the tools 36, 55. During the metal cutting, the tools 36, 55 are driven in a linear manner by means of the slides 29, 33, 45 and 49. The metal cutting is shown in FIGS. 1 to 3.

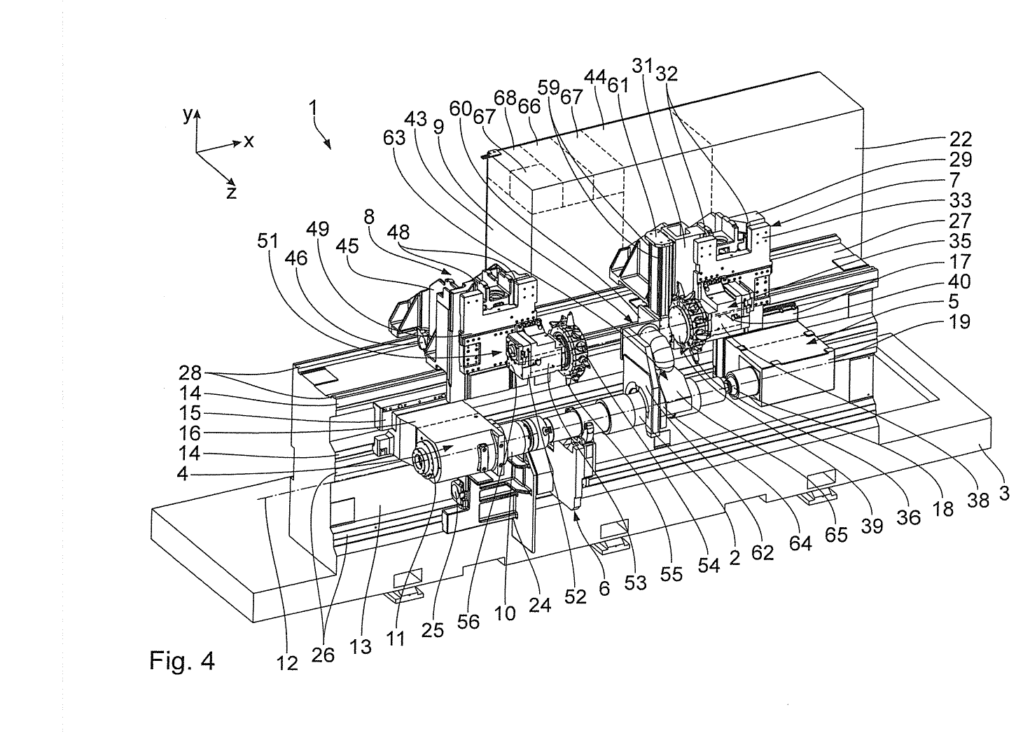

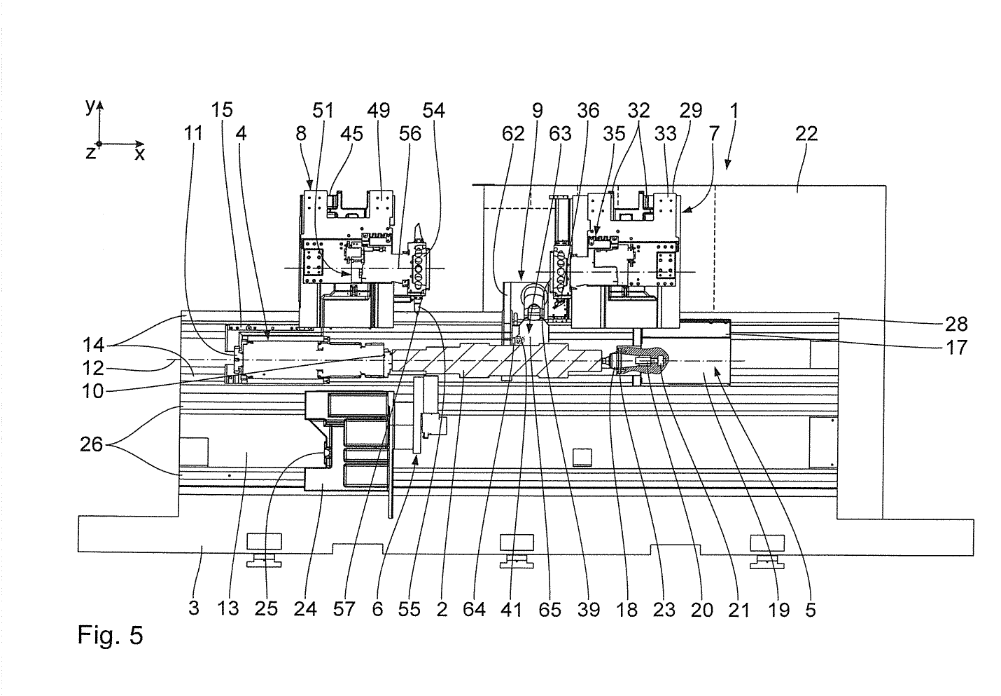

In parallel with the metal cutting, the workpiece 2 is hardened by means of the hardening device 9. For this purpose, the workpiece 2 is heated locally during the metal cutting by means of the heating unit 62 and/or the inductor to the austenizing temperature and then quenched by means of the quenching unit 63. Since the workpiece 2 rotates around the axis of rotation 12 during the hardening, it is uniformly heated and quenched. For quenching, the cryogenic cooling medium 41 is transported by means of the feed pump 66 through the feed line 64 to the workpiece 2, and after arrival at the workpiece 2, is suctioned away again by the feed pump 67 through the suction line 65. Because of the cryogenic cooling medium 41, the workpiece 2 is cooled extremely quickly, whereby the distortion of the workpiece 2 is kept low. During the hardening, the hardening device 9 is driven in a linear manner by means of the slides 29 and 60 in the usual way. Alternatively, the hardening can start only after the metal cutting of the workpiece 2. The hardening is shown in FIGS. 4 and 5.

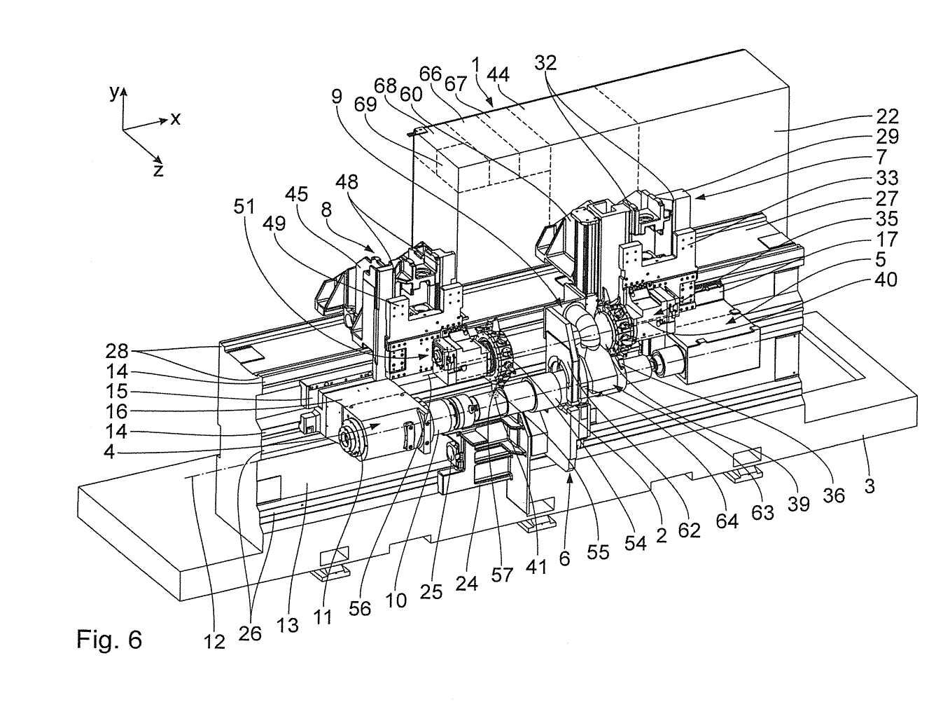

In parallel with the hardening, the fine processing and/or reworking of the hardened workpieces 2 occurs. During the fine processing the workpiece 2 can, for example, be processed with metal cutting or the surface of the workpiece 2 can be improved in other ways. The fine processing occurs by means of the first processing device 7 and/or the second processing device 8. The tools 36, 55 in engagement with the workpiece 2 for fine processing are cooled by means of the cryogenic cooling medium 41. For this purpose, the cryogenic cooling medium 41 is transported by means of the feed pumps 68, 69 from the reservoir tank 43 to the blades of the tools 36, 55. Alternatively, the fine processing may not start until the hardening is completed. The fine processing is shown in FIG. 6.

Because of the cryogenic cooling medium 41, during metal-cutting and/or during fine processing of the workpiece 2, the blades of the tools 36, 55 in engagement are more effectively cooled, whereby the cutting speed and the processing productivity are increased. Because of the fact that the cryogenic cooling medium 41 evaporates at the latest after quenching, the workpiece 2 and the entire machine tool 1 are clean. Disposal of the cooling medium 41, as required with previous cooling media, is eliminated.

During the entire manufacturing process, the axial force acting on the workpiece 2 is measured by the force sensor 21. Axial expansions of the clamped workpiece 2 are compensated within certain limits by the spring element 20. If the axial force measured exceeds a certain limit, in spite of the elastic mounting, the workpiece spindle 4 and/or the tailstock 5 will be adjusted in the x-direction. To prevent large temperature fluctuations on the spring element 20 and/or the force sensor 21, the workpiece holder 18 is thermally shielded by means of the insulation 23. Because of the fact that the metal cutting, hardening and fine processing of the workpiece 2 occurs in a clamping device, on the one hand, a high processing quality and, on the other hand, a shorter processing and/or cycle time is achieved.

Preferably nitrogen is used as cryogenic cooling medium 41. The nitrogen 41 is stored as a liquid at a temperature below its boiling point (−195.79° C. and/or 77.36 K) in the reservoir tank 43. During the transport through the feed lines 42, 57 and 64, the nitrogen 41 can remain liquid up to the arrival at the workpiece 2 and/or the tools 36, 55. Alternatively, the nitrogen 41 can remain gaseous up to the arrival at workpiece 2 and/or the escape from the tools 36, 55 and assume a temperature above the boiling point, but preferably below 180° C. (93.15 K).

In principle, at least one medium from the group including nitrogen, oxygen, hydrogen, helium, argon, carbon dioxide and natural gas can be used as cryogenic cooling medium 41. The cryogenic cooling medium 41 can be liquid and/or gaseous. Upon arrival at the workpiece 2 during metal cutting, hardening and/or fine processing, the cryogenic cooling medium 41 has a temperature of less than −60° C. (213.15 K), and may be less than −120° C. (153.15), and may be less than −150° C. (123.15), and may be less than −180° C. (93.15).

The workpieces 2 to be produced may be, e.g., shafts, gears, pinion shafts, crankshafts, camshafts, gearshift shafts and/or flange parts. The metal cutting and fine processing can occur by turning, lathe milling, cold rolling, tooth cutting, drilling, crankshaft milling, camshaft milling and/or grinding.

1. A method for the processing and hardening of metallic workpieces comprising the steps of:
clamping a workpiece to be processed in a workpiece holder of a machine tool;
metal-cutting processing the workpiece clamped in the workpiece holder; and,
hardening the workpiece by heating the workpiece that is processed and clamped in the workpiece holder and quenching the workpiece that is heated and clamped in the workpiece holder with a cryogenic cooling medium.

2. The method according to claim 1, wherein the cryogenic cooling medium is at least one medium from the group including nitrogen, oxygen, hydrogen, helium, argon, carbon dioxide and natural gas.

3. The method according to claim 2, wherein the cryogenic cooling medium has a temperature of less than −60° C. upon arrival at the heated workpiece.

4. The method according to claim 2, wherein the cryogenic cooling medium has a temperature of less than −120° C. upon arrival at the heated workpiece.

5. The method according to claim 2, wherein the cryogenic cooling medium has a temperature of less than −150° C. upon arrival at the heated workpiece.

6. The method according to claim 2, wherein the cryogenic cooling medium has a temperature of less than −180° C. upon arrival at the heated workpiece.

7. The method according to claim 2, wherein the cryogenic cooling medium arrives at the heated workpiece as a gas.

8. The method according to claim 2, wherein the cryogenic cooling medium arrives at the heated workpiece as a liquid.

9. The method according to claim 2, wherein the cryogenic cooling medium is stored as a liquid.

10. The method according to claim 2, wherein by means of the cryogenic cooling medium, a tool that is used for metal cutting is cooled.

11. The method according to claim 1, wherein the heating and the quenching occurs during the metal-cutting processing of the workpiece.

12. The method according to claim 1, wherein fine processing occurs with the hardened workpiece clamped in the workpiece holder.

13. The method according to claim 12, wherein by means of the cryogenic cooling medium a tool used for fine processing is cooled.

14. The method according to claim 12, wherein the fine processing occurs during the quenching of the workpiece.

15. The method according to claim 1, wherein the workpiece holder is thermally insulated with respect to a base frame of the machine tool.

16. The method according to claim 1, wherein the workpiece is a shaft-shaped and clamped on both ends in a workpiece holder.

17. The method according to claim 16, wherein at least one workpiece holder is spring-mounted for compensating for axial expansions of the clamped workpiece.

18. The method according to claim 17, wherein by means of a force sensor, an axial force is measured on at least one workpiece holder and depending on the axial force, axial expansions of the workpiece are compensated by movement of one of the workpiece builders.

19. A machine tool for processing and hardening metallic workpieces, comprising:
a base frame;
a workpiece holder mounted on base frame for clamping a workpiece to be processed;
a processing device for metal-cutting processing the workpiece;
a hardening device for hardening the processed workpiece;
a heating unit for heating the workpiece;
a quenching unit, whereby the heated workpiece clamped in the workpiece holder can be quenched with a cryogenic cooling medium; and,
a control device for controlling the processing and hardening of the workpiece.
